(19) United States
(12) Patent Application Publication
(10) Pub. No.: US 2010/0247321 A1
(43) Pub. Date: Sep. 30, 2010

(54) ANTI-FOULING COATINGS AND ARTICLES COATED THEREWITH

(75) Inventors: Ambarish Jayant Kulkarni, Niskayuna, NY (US); David Bruce Hall, Ballston Lake, NY (US); James Anthony Ruud, Delmar, NY (US); Guruprasad Sundararajan, Bangalore (IN); Dalong Zhong, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/751,153

(22) Filed: Mar. 31, 2010

Related U.S. Application Data
(63) Continuation-in-part of application No. 11/970,604, filed on Jan. 8, 2008.

(51) Int. Cl. F01D 5/14; B32B 15/04; B32B 15/08

(52) U.S. Cl. 416/223 R; 428/457; 428/626; 428/469

(57) ABSTRACT

An article including a metallic substrate is presented. The article further includes a sacrificial layer disposed on a surface of the substrate and an anti-fouling layer disposed on the sacrificial layer. The anti-fouling layer includes a metal-polymer composite. An article including an anti-fouling layer having a nitride is also presented.

### CROSS REFERENCE TO RELATED APPLICATIONS

This application is a continuation in part of U.S. patent application Ser. No. 11/970,604, entitled “EROSION AND CORROSION-RESISTANT COATING SYSTEM AND PROCESS THEREFOR,” filed on Jan. 8, 2008, which is herein incorporated by reference.

### BACKGROUND

The invention relates generally to protective coatings for turbine components. More particularly, the invention relates to a protective coating for gas turbine compressor components, and components that include such coatings.

Components of industrial and marine gas turbines are subjected in normal use to a variety of operating conditions, particularly with respect to the ambient atmosphere. In some situations the air drawn into the engine has constituents that are corrosive and abrasive to the compressor blades and other such parts. Corrosion is exacerbated if the turbine operates in or near a corrosive environment, such as near a chemical or petroleum plant or near a body of saltwater.

In addition, gas turbine compressor components become fouled with a mixture of hydrocarbon-based lubricating oil, carbonaceous soot, dirt, rust and other like components. For example, compressor blades are susceptible to corrosion pitting along leading edge surfaces of blades resulting from accumulation of fouling particles that cause galvanic attack. The fouling affects the performance of compressor blades or airfoils and reduces efficiency of the gas turbine. Along with technical loses, fouling may further be responsible for some financial loses such as higher fuel consumption, low power generation, and unscheduled maintenance.

On-line periodic water is usually employed to remove deposits on compressor components and to improve the performance of compressors. However, this injected water here may further exacerbate the corrosion problem. Generally these systems entail introducing water droplets at the compressor inlet, with the result that blades of the compressor are impacted by water droplets at high velocities. Compressor blades formed of iron-based alloys, including series 400 stainless steels, are prone to water droplet erosion at their leading edges, including their roots where the blade airfoil attaches to the blade platform.

It has been proposed, consequently, that a protective coating be provided against such fouling and corrosive attack. Various metallic/ceramic coatings have been suggested and tried; none has qualified for technical or economic reasons.

Thus, there is a need to provide an improved protective coating for compressor components. It is desirable that the protective coating be anti-fouling as well as resistant to water droplet and solid particle erosion and corrosion.

### BRIEF DESCRIPTION

In one embodiment, an article including a metallic substrate is provided. The article further includes a sacrificial layer disposed on a surface of the substrate and an anti-fouling layer disposed on the sacrificial layer. The anti-fouling layer comprises a metal-polymer composite.

In another embodiment, an article including a metallic substrate is provided. The article further includes a sacrificial layer disposed on a surface of the substrate and an anti-fouling layer disposed on the sacrificial layer. The anti-fouling layer comprises a nitride.

### DRAWINGS

These and other features, aspects, and advantages of the present invention will become better understood when the following detailed description is read with reference to the accompanying drawings, wherein:

FIG. 1 is a schematic of an embodiment of the present invention;

### DETAILED DESCRIPTION

Embodiments of the present invention include in part a protective coating suitable for gas turbine compressor components. The coating is capable of providing anti-fouling characteristics, and is resistant to erosion and corrosion. The coating is particularly well suited for protecting components formed of iron-based alloys, such as industrial gas turbine compressor blades. These components are generally formed of martensitic/ferritic stainless steels and subjected to oil fouling, water droplet/solid particle erosion and corrosion pitting. Notable examples include first stage compressor blades formed of series 400 martensitic stainless steels such as AISI 403 and proprietary formulations such as GTD-450 precipitation-hardened ferritic stainless steel. While the invention will be described in reference to compressor blades formed of a stainless steel, it should be understood that the teachings of this invention will apply to other components that are formed of a variety of iron-based alloys, superalloys (such as nickel-based and cobalt-based superalloys) and titanium-based alloys; such components may also benefit from improved anti-fouling and resistance to water droplet erosion and corrosion pitting.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and the claims that follow, the singular forms “a”, “an” and “the” include plural referents unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances the event or capacity cannot occur—this distinction is captured by the terms “may” and “may be”.

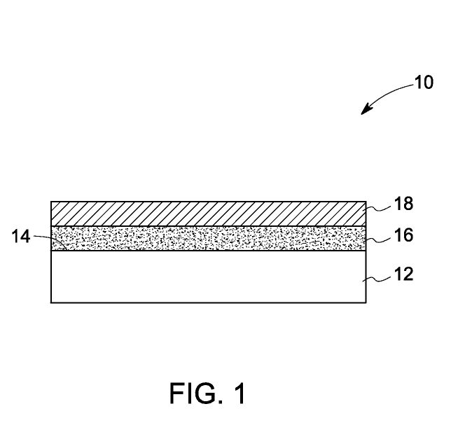

FIG. 1 schematically represents an article 10 according to one embodiment of the invention. The article 10 includes a metallic substrate 12 that may be a component of an industrial gas turbine, for example a compressor blade, an airfoil, or the like. As discussed above, these components (e.g., the metallic substrate 12) are typically formed of iron-based alloys, such as stainless steel. Other suitable materials for the metallic substrate 12 include nickel, titanium, and their respective alloys.

The components are coated with a protective coating for protecting surfaces from the ambient environment. According to one embodiment of the invention, a protective coating is disposed on a surface 14 of the metallic substrate 12. The protective coating includes a sacrificial layer 16 and an antifouling and erosion resistant layer 18 disposed on the sacrificial layer 16. The sacrificial layer 16 contains a metal or metal alloy that is anodic, in the galvanic (electropotential) series, relative to the metallic substrate 12, such that the sacrificial layer 16 behaves as a sacrificial anode to the underlying surface 14 of the substrate 12. As such, the sacrificial layer 16 and the substrate 12 form a galvanic couple, and the sacrificial layer 16 may corrode much more rapidly than any uncoated surface region of the substrate 12. The sacrificial layer 16 basically provides resistance against corrosion of the substrate 12, and hence, may also be referred to as a corrosion resistant layer.

The sacrificial layer 16 can be formed of a variety of compositions that are capable of the above-noted requirement. Materials for the sacrificial layer 16 are also preferably capable of protecting the metallic substrate 12 in the event the anti-fouling layer 18 is eroded away or otherwise spalls, especially in highly corrosive salt environments. In some embodiments, the sacrificial layer 16 is also be capable of withstanding temperatures of at least about 300 degrees Celsius to about 700 degrees Celsius.

The sacrificial layer 16 may include a metal, a metal alloy or an intermetallic. Suitable metals for the sacrificial layer 16 may include, but are not limited to, zinc, aluminum, cobalt and nickel. An alloy of zinc, aluminum, cobalt or nickel may also be applicable for the purpose. One example of an acceptable material composition for the sacrificial layer 16 is commercially offered by the General Electric Company under the name GECC1 (disclosed in U.S. Pat. No. 5,098,797 to Haskell), and contains cobalt and aluminum particles in a chromate/phosphate inorganic binder. The contents of Haskell relating to the GECC1 material, and particularly suitable compositions for the material and suitable particle sizes for the cobalt and aluminum particles, are incorporated herein by reference. Other acceptable materials for the sacrificial layer 16 include nickel and zinc, both of which are known to perform as sacrificial anodes to iron and its alloys. In certain instances, electroless nickel is used in the sacrificial layer 16. In some embodiments, a metal oxide, for example an oxide of zinc, aluminum, cobalt, nickel or a combination of oxides thereof, may also be used. Depending on the particular composition, suitable thicknesses for the sacrificial layer 16 are generally in a range of about 10 micrometers to about 200 micrometers.

The anti-fouling layer 18 is disposed on the sacrificial layer 16 to reduce fouling and increase the effectiveness of water washing. As used herein, an anti-fouling layer provides protection against fouling by a foulant, for example lubricant oil, and further against water droplet and solid particle erosion. Furthermore, the anti-fouling layer 18 preserves the sacrificial layer 16 and its ability to provide resistance to pitting corrosion and crevice corrosion. The protective coating can be strategically placed on the compressor blade with the individual thicknesses of the sacrificial layer 16 and the anti-fouling layer 18 tailored to provide specific benefits for compressor airfoil applications. In some embodiments, the anti-fouling layer 18 may be directly disposed on the surface 14 of the metallic substrate 12. The direct deposition, as used herein, means that the anti-fouling layer 18 is deposited on the surface 14 without the sacrificial layer 16. In these instances, the anti-fouling-layer 18 further has sacrificial properties in a corrosive environment. The coating properties are tailored to have both corrosion and erosion resistance along with the anti-fouling property.

Anti-fouling behavior of the protective coating is mostly affected by the surface properties of the anti-fouling layer, such as surface roughness, surface texture or morphology, oleophobicity and hydrophobicity of the surface and surface energy. These properties are very sensitive to the quality of the layer and can be characterized based on parameters such as foulant contact angle to the surface, foulant resistance, and solid particle erosion.

As used herein, the term “contact angle” is the angle formed by a static liquid droplet on the surface of a solid material. The higher the contact angle, the less the interaction of the liquid with the surface. Thus, it is more difficult for the foulant to wet or adhere to the surface if the contact angle of the oil or other foulant with the surface is high. For example, the contact angles of the surface of the anti-fouling layer 18, according to some embodiments of the invention, with respect to lubricant oil, may be greater than about 90 degrees. In certain instances, the contact angles may be greater than about 120 degrees.

“Oleophobicity of a surface” or “Oleophobic” refers to the physical property of a material that is oil repellent. “Hydrophobicity of a surface” or “Hydrophobic” refers to the physical property of a material that is water repellent. Specifically, surfaces with low surface energy for the foulant should have a high contact angle and should provide reduced adhesion with the foulant relative to a surface which is wet by the foulant or with which the foulant has low contact angle.

An effective anti-fouling coating typically has good solid particle erosion resistance to prevent the thin coating from wearing away in a short period of time. Erosion also changes surface roughness of the layer or coating and may lead to enhanced fouling. Ideally, the coating should have better solid particle erosion resistance than the substrate. No universal model exists that can predict solid particle erosion resistance for a variety of materials. Erosion resistance is typically analyzed in terms of erosion rate that may depend on a variety of factors including coating and particle modulus/hardness, particle morphology, impact speed and angle etc. As used herein, the term “erosion rate” refers to the rate at which impinging solid particles wear away a layer or coating or a surface of a coating. The erosion rate is measured as mass of material worn away per unit time. According to embodiments of the invention, the anti-fouling layer 18 has good solid particle erosion resistance. In other words, the antifouling layer 18 exhibits lower solid particle erosion rate than the metallic substrate 12. Some examples of erosion resistance measurements are described below.

Most of the surface properties, as mentioned above, of a layer or coating may depend on material and method used for disposing the layer. The anti-fouling layer 18, in accordance with one embodiment of the invention, includes a metal-polymer composite. These composites are materials having a metal matrix with a polymer dispersed in the metal matrix. The metal matrix provides solid particle erosion resistance and toughness to the layer. Examples of metals for the matrix may be selected from the group consisting of nickel, chromium, and aluminum.

The polymers present in the anti-fouling layer significantly affect the characteristics of the protective coating such as surface energy and oleophobicity. Fluorinated groups are particularly effective in reducing surface energy and making the layer oleophobic. Fluoropolymer such as polytetrafluoroethylene (PTFE) is a particularly suitable example of the polymer to be disposed in the metal matrix to form the composite. Other examples may include silicones. The amount of polymer present in the metal-polymer composite may vary from about 1 volume percent to about 50 volume percent. In some embodiments, the amount of polymer may vary from about 10 volume percent to about 25 volume percent.

Various methods can be used for depositing the metal-polymer composite layer or coating. Electroless deposition is one acceptable method. A micron-sized polymer emulsion is introduced into a plating bath and the polymer is co-deposited with the metal throughout the coating. One example of such coating is electroless nickel codeposited with polytetrafluoroethylene (PTFE) from General Magnaplate. Other suitable methods may include sol-gel, electroplating and electroless deposition followed by polymer infusion. Sub-micron particles of the fluoropolymer may be infused into a porous metal matrix through ultrasonic treatment and/or heat and pressure treatment. Examples of such coatings are TFE-LOK, Endura 200, as described in Table 1 below.

In another embodiment, the anti-fouling layer is formed of nitrides. Examples of suitable nitrides are selected from the group consisting of zirconium nitride, chromium nitride, titanium nitride, titanium aluminum nitride, chromium aluminum nitride or a combination thereof. Suitable methods for depositing the nitride layer may include physical vapor deposition, sputtering, chemical vapor deposition, and thermal spray techniques. For example, chromium nitride, titanium nitride and zirconium nitride layers can be reactively deposited from a chromium, titanium and zirconium targets, respectively, using magnetron sputtering, electron beam physical vapor deposition, or filtered vacuum arc evaporation in partial pressure of nitrogen atmosphere.

Because of the aerodynamic requirements of compressor blades, surface finish of the anti-fouling layer 18 is of importance, and the surface roughness of the anti-fouling layer 18, in some embodiments, is less than about 32 micro inches (i.e. 0.8 micrometers) Ra. Furthermore, higher surface roughness may have an adverse effect on the fouling properties. The erosion resistance of the anti-fouling layer 18 prevents the increase in roughness during service and consequently prolongs the antifouling life of the coating.

The protective coating advantageously provides a solution to major issues of corrosion, erosion and fouling. The sacrificial layer is capable of providing corrosion protection and the anti-fouling layer exhibits anti-fouling and erosion resistant properties. Embodiments of the invention provide an anti-fouling layer with low surface energy, which is capable of reducing foulant accumulation on the surface and enhances cleaning capability. These surfaces also exhibit high erosion resistance. Moreover, less maintenance requirements and reduced frequency of water wash may result in significant cost saving and improved efficiency of gas turbines.

### EXAMPLES

The examples that follow are merely illustrative, and should not be construed to be any sort of limitation on the scope of the claimed invention.

A few coatings were investigated to measure their performance by performing the following tests: solid particle erosion test, fouling test, and corrosion resistance test. In these investigations, the test specimens, GTD-450 substrates, were coated by physical vapor deposition (PVD). Table 3 shows coating materials along with their description.

### Example 1

### Solid Particle Erosion Test

Solid-particle erosion measurements were performed with an Airbrasive jet machine at about 25 degrees Celsius. Test conditions are given in Table 1 below. Each GTD-450 substrate was coated with a composite coating material or a nitride as listed in Table 3. Erosion rates were calculated as mass loss per unit time. Table 1 shows average particle erosion rate along with comparison with a few metal coatings and GTD-450 substrate without any coating. Zirconium nitride and titanium nitride coatings had very good erosion resistance, approximately 10 times better than uncoated GTD-450 substrate. A metal-polymer composite, TFE-Lok Chrome PTFE coating, showed slightly better erosion resistance than uncoated GTD-450 substrate.

TABLE 1
Test conditions for solid particle erosion test

| Nozzle | 0.026″ dia. Sapphire |
|---|---|
| Powder Feeder | Plasmadyne |
| Powder Feed Rate (grams/min) | 5 |
| Powder Type | Minetec Quartz particles |
| Average Particle Size | 50 microns |
| Carrier Gas Type matter | Air |
| Carrier Gas Flow Rate (liters/min) | 8 |
| Supply Pressure (psi) | 30 |
| Hopper Pressure (psi): | 22 |
| Gun to Substrate | 0.284 inches |
| Erosion Angle | 20 degrees |
| Powder speed (m/s) | 70 |

### Example 2

### Fouling Test

Each GTD-450 substrate was coated with a composite coating material or a nitride as listed in Table 3. The fouling test was conducted with a fouling rig creating a dynamic environment to simulate accelerated foulant and water wash. The rig contained a blow down wind tunnel with a test cross-section that created flow speeds of up to 0.7 Mach. The samples were developed from a ⅓rd scale inlet guide vane (IGV) section. Five samples were arranged 1 inch apart such that the throat ratio in the sample configuration was the same as that in a typical turbine compressor. With this sample arrangement in the test section, the wind tunnel was calibrated to achieve 0.4 Mach, which was the set flow speed for all tests conducted. The foulants chosen were a mixture of Mobil DTE 832 gas turbine lube oil with 0.25% carbon black. Carbon black was added to mimic particulate layer formation on oil films.

The fouling tests were divided into four stages: (I) oil flow, (II) aero impact, (III) water wash and (IV) air dry. At the start of the test and end of each stage, samples were weighed to determine the foulant deposition. In the first stage (I), with the airflow at 0.4 Mach, oil droplets with carbon black were sprayed from fouling nozzles situated in the upstream section of the wind tunnel. The foulant droplets were accelerated to flow speed and impinge on the blade arrangement in the test section. Test conditions are given in Table 2. The foulant flow was maintained for about 60 min, which corresponds to a field condition of 6 weeks accounting for the acceleration in the rig test. In stage (II), the foulant flow was discontinued and the effect of flow on the accumulation was determined (20 min duration). In stage (III), water was sprayed through the water wash nozzles for 6.5 min and the samples were air dried (stage IV) to obtain total accumulation after water wash. The results for initial oil accumulation and accumulation after water wash are given in Table 3. Metal-polymer composite coatings, Nedox and TFE-Lok Chrome-PTFE, showed significantly improved performance after water wash as compared to GTD-450 substrate. Improved water wash performance indicates that the foulant has lower adhesion to the coated substrate than uncoated GTD-450 substrate. Nedox coating, zirconium nitride coating and titanium nitride coating showed excellent performance. These coatings had initial accumulation lower than the uncoated GTD-450 substrate and further reduced accumulation after water wash.

TABLE 2
Test Conditions for Fouling Test

| | |
|---|---|
| Flow speed | 0.4 Mach |
| Oil specification | Mobil DTE 832 |
| Volume flow rate of oil/particles | 1.2 GPH |
| Oil droplet sizes | 20 microns |
| Particulate matter specification | Alfa Aesar carbon black |
| Mass fraction of particulate matter | 0.25% |
| Volume flow rate of water | 3 GPH |
| Water droplet sizes | DV90-150 um |

TABLE 3

| | | | | | Accumulation |
|---|---|---|---|---|---|
| | | | Average | Initial | after water |
| | | | Erosion Rate | accumulation | wash |
| Coating ID | Company | Description | (mgs/min) | (mgrams) | (mgrams) |
| Uncoated | — | — | 2.60 | 7 | 6 |
| GTD-450 | | | | | |
| Nedox | General | Electroless nickel with | 4.84 | 2 | 1 |
| | Magnaplate | PTFE infusion | | | |
| TFE-Lok | Peter | Hard chrome infused | 2.20 | 9 | 1 |
| Chrome- | Schreiber | with PTFE | | | |
| PTFE | GmbH | | | | |
| Titanium | Northeast | Single layer 2.5 μm | 0.07 | 3 | 2 |
| nitride (TiN) | Coating | titanium nitride | | | |
| | Technologies | deposited via electron | | | |
| | | beam physical vapor | | | |
| | | deposition | | | |
| Zirconium | Northeast | Single layer 2.5 μm | 0.11 | 3 | 2 |
| nitride (ZrN) | Coating | zirconium nitride | | | |
| | Technologies | deposited via electron | | | |
| | | beam physical vapor | | | |

### Example 3

### Corrosion Resistance Test

Corrosion resistance measurements were performed with a potentiostat. About 1 cm² of intact coating was externally coupled electrically to a small area of a polished GTD-450 pin (edge of the pin) embedded in an epoxy matrix. The system was immersed in 5% chloride medium at 50 degrees Celsius. The galvanic current and potential were measured by the potentiostat over about 48 hr time period.

Three samples of coating-substrate systems were developed for measurements. The first sample was a GTD-450 substrate coated with titanium nitride (TiN) coating. The second sample had an aluminum layer applied by High-Velocity Air Fuel spraying (HVAF) deposition technique over a GTD-450 substrate. The third sample was prepared by coating a titanium nitride layer over an aluminum layer similar to the second sample. The samples were polished to less than 1-micron average roughness. The TiN coating was subsequently deposited by physical vapor deposition (PVD).

The galvanic potential measurement results are given in Table 4 below. Results indicate that the galvanic potential of the third sample, that is, for the Al+TiN coating-substrate system, was more negative than the first sample (TiN coating-substrate system). Correspondingly, the galvanic currents were also positive which indicates that the aluminum coating dissolved sacrificially in the chloride medium thereby protecting the substrate from corrosion.

TABLE 4
Galvanic Potential Measurements

| | | Galvanic | Galvanic current |
|---|---|---|---|
| Sample | Coating system | potential (mV) | (nano-Amp/cm²) |
| First | GTD450 + TiN | −280 | −34 |
| Second | GTD450 + Al | −1000 | 975 |
| Third | GTD450 + Al + TiN | −800 | 575 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. An article, comprising:
a metallic substrate,
a sacrificial layer disposed on a surface of the substrate, and
an anti-fouling layer disposed on the sacrificial layer, wherein the anti-fouling layer comprises a metal-polymer composite.

2. The article of claim 1, wherein the metallic substrate is a component of an industrial gas turbine.

3. The article of claim 2, wherein the component comprises a compressor blade.

4. The article of claim 2, wherein the metallic substrate comprises at least an airfoil surface.

5. The article of claim 4, wherein the metallic substrate comprises stainless steel, nickel, titanium or an alloy thereof.

6. The article of claim 1, wherein the sacrificial layer comprises a metal, a metal alloy, or an intermetallic.

7. The article of claim 6, wherein the sacrificial layer comprises a metal selected from the group consisting of zinc, aluminum, and nickel.

8. The article of claim 1, wherein the sacrificial layer comprises a metal oxide.

9. The article of claim 1, wherein the metal-polymer composite comprises a fluoropolymer.

10. The article of claim 1, wherein the metal-polymer composite comprises a metal selected from the group consisting of nickel, chromium, and aluminum.

11. The article of claim 1, wherein the metal-polymer composite comprises an amount of a polymer varying from about 1 percent to about 50 volume percent.

12. The article of claim 1, wherein the anti-fouling layer comprises a polymer disposed in a metal matrix.

13. An article, comprising:
a metallic substrate,
a sacrificial layer disposed on a surface of the substrate, and
an anti-fouling layer disposed on the sacrificial layer, wherein the anti-fouling layer comprises a nitride.

14. The article of claim 13, is a component of an industrial gas turbine.

15. The article of claim 14, wherein the component comprises a compressor blade.

16. The article of claim 14, wherein the component has a metallic substrate and the metallic substrate comprises at least an airfoil surface of the component.

17. The article of claim 16, wherein the metallic substrate comprises steel, stainless steel, nickel, titanium or an alloy thereof.

18. The article of claim 13, wherein the sacrificial layer comprises a metal, a metal alloy, or an intermetallic.

19. The article of claim 18, wherein the sacrificial layer comprises a metal selected from the group consisting of zinc, aluminum, and nickel.

20. The article of claim 13, wherein the sacrificial layer comprises a metal oxide.

21. The article of claim 13, wherein the nitride is selected from the group consisting of zirconium nitride, chromium nitride, titanium nitride or a combination thereof.

22. The article of claim 13, wherein the nitride comprises titanium aluminum nitride or chromium aluminium nitride.
